(19) United States
(12) Patent Application Publication
(10) Pub. No.: US 2011/0278860 A1
(43) Pub. Date: Nov. 17, 2011

(54) FISHING REEL POWER GENERATOR

(76) Inventor: ANTHONY LUPINACCI, Lorain, OH (US)

(21) Appl. No.: 13/107,957

(22) Filed: May 15, 2011

Related U.S. Application Data
(60) Provisional application No. 61/345,101, filed on May 15, 2010.

(51) Int. Cl. H02N 11/00

(52) U.S. Cl. 290/1 R

(57) ABSTRACT

A fishing reel power generator system is for generation of power on a reel assembly coupled to a fishing rod. The power generation system includes a reel assembly having a gear track, a hand crank capable of being rotated a gear of the gear track; a geared end electrical generator coupled to gear of the gear track for generating electrical energy by converting the rotatory motion of the hand crank into electrical energy; and power storage unit coupled to the generator for storing the generated electrical energy. A removable handle includes a generated electrical energy which may be used for purposes such as powering LED lights located on the fishing rod or on the reel assembly, a bite indication unit and one or more electronics devices external to the fishing reel and the fishing rod, such as cellular phones, personal digital assistants (PDAs), flashlight, global positioning systems (GPS), radio, etc.

### CROSS-REFERENCE TO RELATED APPLICATION

This application claims the benefit of Provisional Patent Application No. 61/345,101 filed on May 15, 2010, in the United States Patent & Trademark Office, the disclosure of which is incorporated herein by reference.

### FIELD OF INVENTION

The present invention relates to fishing equipment. More particularly, the present invention provides a system for generation of power on a fishing reel coupled with a fishing rod.

### BACKGROUND OF THE INVENTION

Although daytime fishing is usually preferred among most fisherman, fishing during early morning, late evening, and even at night, when there is low ambient sunlight, often proves to be more productive. People who fish at night often carry various pieces of equipment, including lights, radios, and other necessary electronics other than. Portable electric appliances, such as cellular phones, Personal Digital Assistants (PDAs), radios, etc., usually operate by using electrical energy stored in batteries or upon being connected to a power source to operate. In order to enjoy uninterrupted use of such electronic appliances their battery must be continuously replaced or recharged due to the limited storage capacity of the battery.

Hence, usually people carry spare batteries along with other necessary fishing equipment in night fishing trips. However, each piece of equipment can have different power requirements, which may cause users to carry several types of spare batteries and power sources. This can be very cumbersome and inconvenient, and may cause users to constantly worry about their equipment, rather than enjoying their fishing trips. An effective solution is necessary. Several patents and patent applications disclose fishing equipment provided with one or more lights for providing illumination during night time fishing.

US Patent Application 20070283612, filed on Dec. 13, 2007 by Shaw; Terena et al. describes a fishing rod provided with a lighting system that includes a timer circuit and a motion responsive switch. In response to motion, the timer circuit activates lights to illuminate the fishing rod for a pre-determined interval. The circuit extinguishes the lights at the end of the interval. The fishing rod described is fabricated of a translucent material and the lights are LEDs housed within the core of the fishing rod.

Another US Application 20040159039, filed on Aug. 19, 2004 by Yates, Clifford A. et al. describes an illuminated fishing rod comprising a handle and an elongated pole, both having a hollow internal cavity. The internal cavity of the elongated pole houses an electroluminescent wire along its length that illuminates the pole. The electroluminescent wire is connected to an optionally rechargeable power source that is mounted in the cavity of the handle.

Yet another U.S. Pat. No. 7,051,470, issued on May 30, 2006 to Lybarger et al. describes a battery-powered lighted fishing rod including: a handle having a forward end; a shaft extending from the forward end of the handle; an electroluminescent lamp secured the shaft; and a power source for supplying electrical power to the electroluminescent lamp. The handle includes a housing which houses a battery and a DC-to-AC inverter for converting the relatively low battery voltage to a relative high AC voltage suitable for driving the electroluminescent lamp and a cover.

Another U.S. Pat. No. 6,546,665, issued on Apr. 15, 2003 to Eldredge et al. describes an illuminated fishing rod including a light source unit removably received in a handle section of the fishing rod. The light source unit includes an LED light source that is located to illuminate a fiber optic bundle located in a blade section of the fishing rod. The light source unit can also be used as an auxiliary light source, such as a flashlight, when it is removed from the fishing rod.

Yet another U.S. Pat. No. 5,738,433, issued on Apr. 14, 1998 to Sparks; Kevin D. describes a fishing pole which is automatically illuminated when a fish strikes the fishing line. The fishing pole includes a handle in which is provided a light bulb and a power source. The rod projecting from the handle either includes a hollow core or is provided with fiber optics which internally pass or externally wrap along the length of the rod. When a sensor mounted at the tip of the rod senses a fish strike on the fishing line, the light bulb is caused to light up and project light into the hollow core or fiber optics to cause the rod to be illuminated along its length.

Most of the available fishing equipment provides for illuminated fishing rods powered by batteries that need to be charged or replaced once they run out. Accordingly, there is a need for a power generation system that can provide light for night fisherpersons, as well as power other electrical equipment.

There is need for a power generation system which is easy to use and eliminates the need for fisherpersons to carry extra equipment or back-up equipment to prepare for possible failure of electronics.

The present invention satisfies these needs, as well as others, and generally overcomes the deficiencies found in the background art.

### SUMMARY OF THE INVENTION

The present invention is directed towards system for generating power on a reel assembly coupled with a fishing rod when a hand crank of the reel assembly is rotated. A hand crank power generator is mounted on a body of the reel assembly and is used for generating electrical energy which is used to illuminate one or more LED light bulbs provided on the reel assembly and/or the fishing rod. The generated electrical energy is also used to charge rechargeable batteries provided in a handle of the fishing rod and also for powering external electrical equipment such as a cellular phone, PDA, GPS, radio, etc.

In an embodiment, the present invention provides a system for generation of power on a reel assembly coupled to a fishing rod. The power generation system comprises: a reel assembly comprising a hand crank capable of being rotated; a generator coupled to the reel assembly for generating electrical energy by converting the rotatory motion of the hand crank into electrical energy; and power storage means coupled to the generator for storing the generated electrical energy. The hand crank is rotated both for deployment and retrieval of a fishing line mounted on the fishing rod and for operating the generator. In an embodiment, the generator is coupled to a body of the reel assembly in a molded housing by way of a slide component, while in another embodiment, the generator is fixedly connected to the body of the reel assembly. In an embodiment, the generator generates electrical energy ranging from 3 to 12 VDC Volts.

In an embodiment, the generated electrical energy is used to power one or more LED lights located on the fishing rod, while in another it is used to power one or more LED lights located on the reel assembly, and in yet another embodiment, the generated electrical energy is used to power a bite indication unit located near a tip of the fishing rod. In another embodiment, the generated electrical energy is used to power one or more devices external to the fishing reel and the fishing rod, such as cellular phones, personal digital assistants (PDAs), global positioning systems (GPS), flashlight, radio, etc.

In an embodiment, the power storage means comprises one or more rechargeable batteries, while in another the power storage means comprises one or more super capacitors. In an embodiment, the power generation system further comprising a switch for engaging and disengaging the generator from the hand crank, and a charge regulator for regulating the electrical energy being stored in the power storage means. In another embodiment, the power storage means are located within a removable handle portion of the fishing rod, the generated electrical energy being fed to the power storage means by means of electrical wires routed inside the reel assembly.

In an embodiment, the generated electrical energy is used to power one or more devices via an auxiliary jack located on a reel seat of the fishing rod, the electrical energy store in the power storage means being conveyed to the auxiliary jack by electrical wires. In another embodiment, the generated electrical energy is used to power one or more devices via an electrical distribution board located on the fishing rod, the electrical energy store in the power storage means being conveyed to the electrical distribution board by electrical wires.

### BRIEF DESCRIPTION OF THE ACCOMPANYING DRAWINGS

The present invention is described by way of embodiments illustrated in the accompanying drawings wherein:

FIG. 1A illustrates a block diagram of the power generation system, in accordance with an embodiment of the present invention;

FIG. 1B illustrates a circuit diagram of an exemplary charge regulator, in accordance with an embodiment of the present invention;

FIG. 2A illustrates the power generation system, in accordance with a fishing rod;

FIG. 2B illustrates the power generation system, in accordance with an embodiment of the present invention;

FIG. 2C illustrates the power generation system, in accordance with a geared track;

FIG. 2D illustrates the bite indicator unit;

FIG. 2E illustrates the electrical generator;

FIG. 3A illustrates a fishing equipment employing the power generation system being used by a fisherperson, and

FIG. 3B illustrates a handle of fishing equipment employing the power generation system being used by a fisherperson.

### DETAILED DESCRIPTION OF THE INVENTION

The Fishing Reel Power Generator disclosed by the present invention provides for generation of electrical power on a fishing rod. The generated power may be used for powering a LED light source on the fishing rod for night fisherpersons, or for powering other electrical equipment. In an embodiment, the Fishing Reel Power Generator generates electricity on an action reel mounted on a fishing rod and the generated electricity is used to power one or more LED lights located on the reel and the fishing rod. Further, the generated electricity may also be stored in a storage means such as, but not limited to, battery or capacitor, and may then be used for powering other electrical equipment, such as, but not limited to, independent lights, radios, and other items requiring electrical sources.

In an embodiment, the present invention discloses a system for generation of power on one or more fishing equipment while the fishing equipment is being used. The fishing equipment comprises at least a fishing rod coupled with a reel and spool assembly. The power generation system of the present invention may be used to generate power on all types of fishing rod and reel assemblies by making minor design modifications to the same, as would be apparent to persons skilled in the art. The present invention may be used during night time fishing for powering one or more LED light bulbs situated on a rod and reel portion of the fishing equipment as well as for powering various electronic equipments such as but not limited to phones, PDAs, GPS, flashlight, radio, etc.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

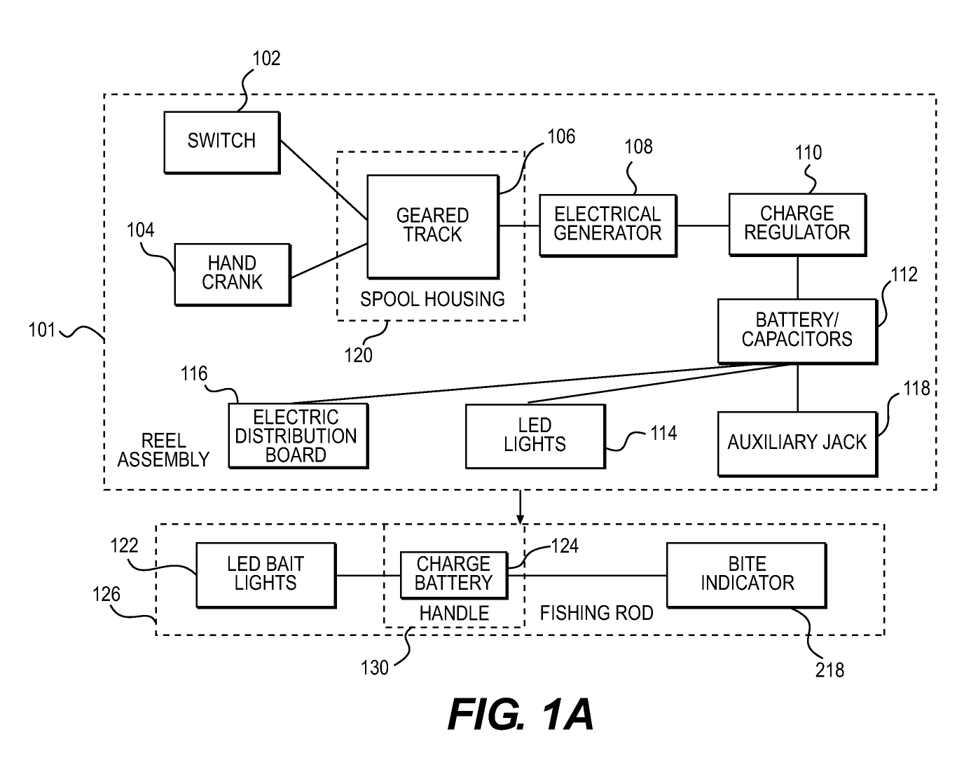

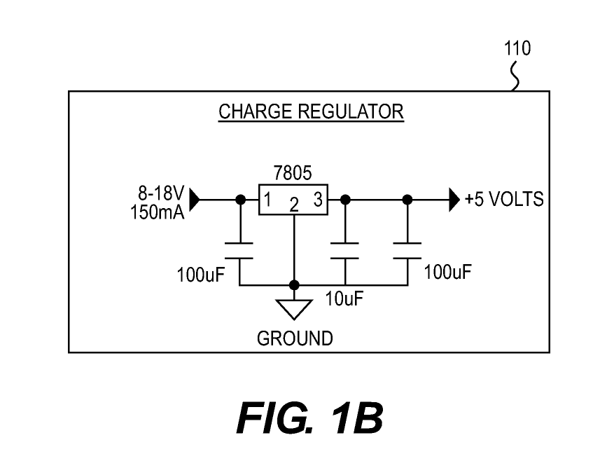

FIG. 1A illustrates a block diagram of the power generation system, in accordance with an embodiment of the present invention. The power generation system is coupled with a reel assembly 101, and comprises a switch 102, a hand crank 104, a geared track 106, a generator 108, a charge regulator 110, a power storage means such as battery 112, at least one LED light bulb 114, an electric distribution board 116, and an auxiliary jack 118. The geared track 106 is meshed with the generator 108 and is located on a spool housing 120 coupled with the reel assembly 101. In an embodiment, the geared track 106 is connected with an electrical system comprising at least a LED bait light 122 and a optional chargeable battery 124 located on fishing rod 126 that is coupled with the reel assembly 101. In an embodiment, the geared track 106 may be connected with the electrical system by means of electric wires for carrying electric power generated on the reel assembly to the battery 124 for lighting the LED bait light 122. In an embodiment, a switch is provided in conjunction with the LED bait light 122 for turning the LED bait light 122 on or off.

The hand crank 104 and the geared track 106 are coupled to each other such that on operating the hand crank 104 a rotor of the generator 108 spins and generates electricity. In an embodiment, the electrical or electricity generator 108 is a small DC generator capable of generating approximately 3 to 12 VDC Volts. In other embodiments, various other generator specifications may be employed to obtain a desired power level. The hand crank 104 comprises at least an arm and a handle attached to an end of the arm. The geared track 106 enables the generator 108 to be operated at a higher speed with a relatively less effort of rotating the hand crank 104. In an embodiment, a single hand crank is provided for performing the functions of both operating the reel for deployment and retrieval of fishing line as well as for operating the generator. The switch 102 is used for engaging and disengaging the generator 108. In another embodiment a separate hand crank for operating the generator 108 may be provided.

Hand crank power generators that convert mechanical motion into electric power are well known in the art. The method of generation of electricity by the spinning of a rotor of the generator 108 upon rotating the hand crank 104 is based on known principles of power generations. Hence, the exact electrical equipment used for the same is not described in detail here so as not to unnecessarily obscure the invention. The design of the equipment needed to generate power on the reel assembly 101 may be modified to suit individual requirement without departing from the scope of the present invention.

The electric power generated by the generator 108 is captured by a series of wires and stored in power storage means 112 which may be one or more batteries or capacitors via the charge regulator 110. The electric distribution board 116 comprising electrical circuitry, such as are well known in the art, may then be used for distributing the stored current to one or more desired applications. In an embodiment, the power storage means or unit 112 are connected via a switch to one or more LED lights 114 located on the reel assembly 101. The LED lights 114 may be switched on for illuminating the surrounding area during night time fishing. In an embodiment, the reel assembly 101 as well as the fishing rod 126 comprise auxiliary jack 118 respectively for connecting with and powering ancillary devices capable of accepting electrical charges, such as phones, radios, GPS, flashlight . . . etc. Further, in an embodiment, the electricity generated may also be used for powering a bite indicator unit 218 coupled with the fishing rod 126. In an embodiment, the power storage means 112 are located within a handle portion 130 of the fishing rod 126. A charge indicator 224 is used to indicate the percentage of charging (e.g. low, middle, fully charge).

In FIG. 1B, the charge regulator 110 comprises a diode, an electrolytic capacitor of 100 μF, a voltage regulator integrated chip (L7805), an electrolytic capacitor of 10 μF, and a ceramic capacitor of 100 nF. The FIG. 1B illustrates a charge regulator circuit diagram 110 of an exemplary charge regulator, in accordance with an embodiment of the present invention. The input can be 8-18 Volts and 150 mA. The output can be regulated at +5 Volts.

In other embodiments, various other charge regulators may be used by persons of skill in the art for regulating the charging and discharging of the power storage means 112. In an embodiment, the power storage means 112 may be a re-chargeable battery having a capacity of 3-4 volts. In another example a super capacitor may be employed for storing the generated power. In various embodiments, as would be apparent to those skilled in the art, other circuitry may be employed to regulate the voltage needed to charge internal or external batteries or capacitors, or generate any voltage desired. In an embodiment, electric circuitry is employed to monitor the charge level and or shunt or stop the re-chargeable battery from overcharging.

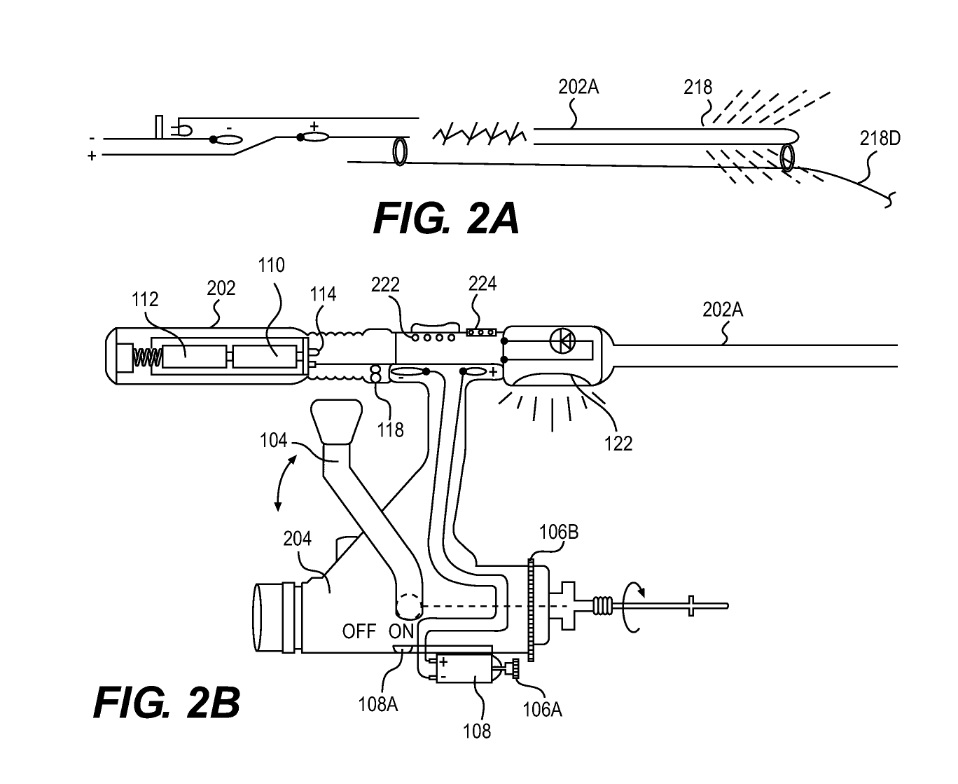

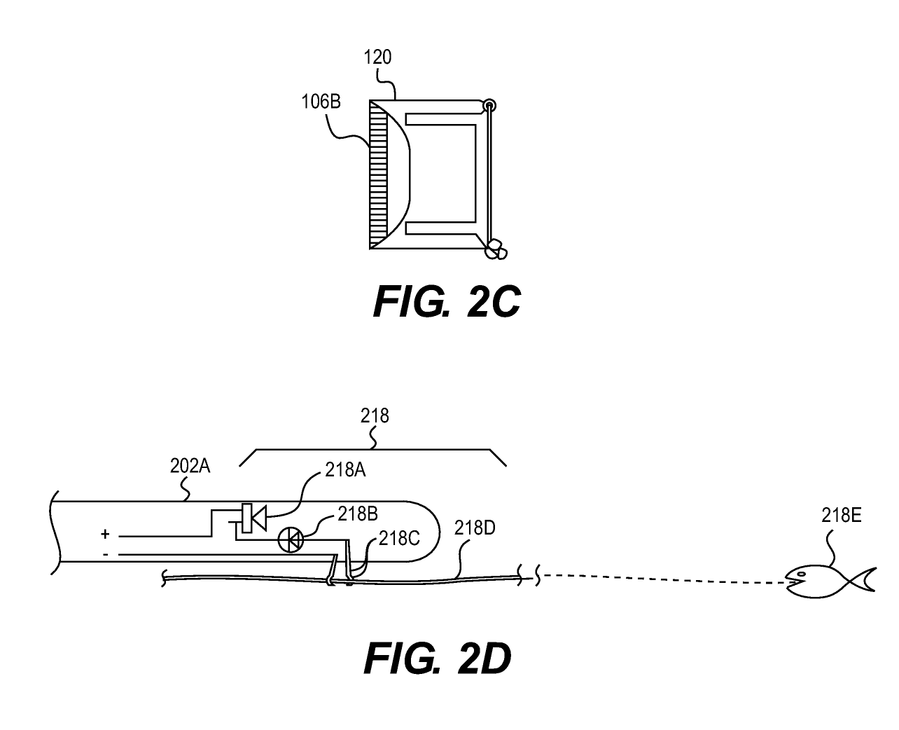

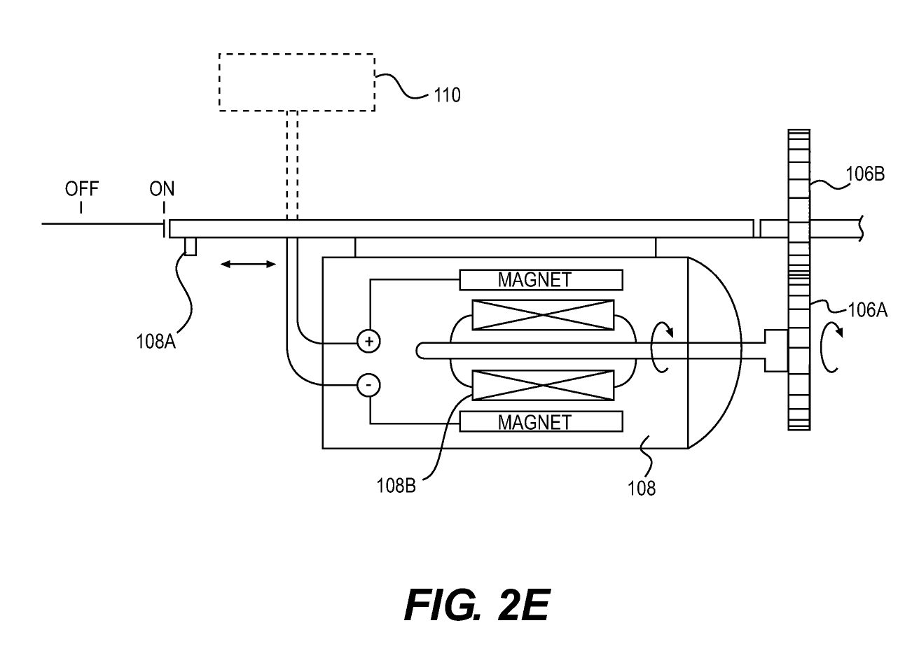

FIG. 2A discloses a fishing rod 202A having a bite indicator unit 218. Also in an embodiment, the stored electric energy is used to power a bite indicating unit 218 provided near a tip of the rod portion 202A. Bite indicating equipment to be used in conjunction with a fishing rod are well known in the art and usually require electrical energy for operation. Any such bite indicating unit 218 coupled with the rod portion 202A may be powered by the electrical energy generated by the power generation system of the present invention.

FIG. 2B illustrates the power generation system, in accordance with an embodiment of the present invention. The figure illustrates a portion of a fishing equipment comprising a handle portion 202, a rod portion 202A an elongated reel and spool assembly 204, an electrical power generator 108 for generating electric power when spun by means of a hand crank 104. In an embodiment, the electrical power generator 108 is externally and detachably mounted on the reel and spool assembly 204. In different embodiments, the generator 108 may be attached to the reel body in a molded housing by way of a slide component or attached in a fixed position. A slide switch 108A is capable of engaging or disengaging the electrical power generator 108 with a geared track 120. The generator 108 has a rotor with a gear 106A.

The hand crank 104 is connected to a geared track 120 which in turn is connected to the electrical or electricity generator 108. The geared track 120 is mounted on the reel and spool assembly 204 and enables the rotor of the generator 108 to be spun at a higher speed with a relatively less effort of rotating the hand crank 104. In another embodiment, the hand crank 104 maybe connected directly to the generator 108. In an embodiment, a single hand crank 104 is provided for performing the functions of both operating the reel for deployment and retrieval of fishing line as well as for operating the electrical or electricity generator 108. In various embodiments, the hand crank 104 combined to operate the generator 108, works as a hand crank power generator well known in the art for generating electric current by converting mechanical circular movement of the hand crank 104 into electric power to charge rechargeable batteries 112. An LED light 114 is provided on the handle portion 202. The LED 114 is powered by the rechargeable batteries 112 and may be designed to light up when the batteries 112 are being charged. The electrical energy stored in the rechargeable batteries 112 is used to power at least one or more LED light bulb 122 on the rod portion 202A.

In an embodiment, the generated electric power is used to power various electrical equipment such as PDAs, cellular phones, radios, etc., via an auxiliary jack 118 provided on the handle portion 202 or an electrical distribution board 222 provided on the rod portion 202A.

In an embodiment, electrical wires carrying the generated electrical energy in the reel and spool assembly 204 are routed inside the reel and spool assembly 204 and terminate at positive and negative cathodes located on a reel seat and exposed as contacts mated to the handle portion 202. The reel and spool assembly 204 may or may not be permanently attached to the handle portion 202. The handle portion may or may not have exposed contacts for engaging the reel seat contacts. In an embodiment, where the handle portion is permanently attached to the reel seat, the positive and negative wires can be routed uninterrupted to a charge control circuit.

FIG. 2C, the geared track 120 has a circular gear 106B which is engaged or disengaged with the gear 106A of the geared end slidable generator 108.

FIG. 2D, the bite indicator unit 218 is located near the tip of fishing rod 202A. The bite indicator unit 218 has a low power battery 3 Volts, a buzzer 218A, an LED light 218B, a fishing line metal clamp 218C for holding fishing line 218D. The buzzer 218A, the LED light 218B are ON when the fishing line 218D is pulled out of the metal clamp 218C by a fish 218E.

FIG. 2E illustrates the details of the electrical or electricity generator 108 having a rotor 108B with a gear 106A at the end. A slide switch 108A can engage and disengage the generator 108 with a rotating gear 106B of geared track. The rotor 108B is rotated between magnets so it can generated voltage output with direct current. The output of generator 108 is fed into the charge regulator 110. The output voltage is in the range of 3-12 Volts.

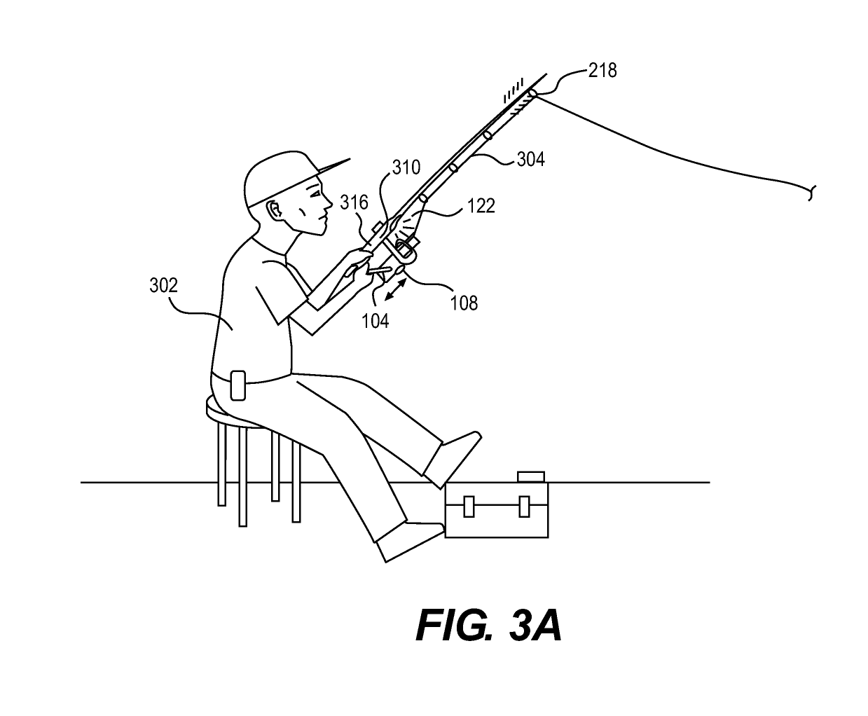

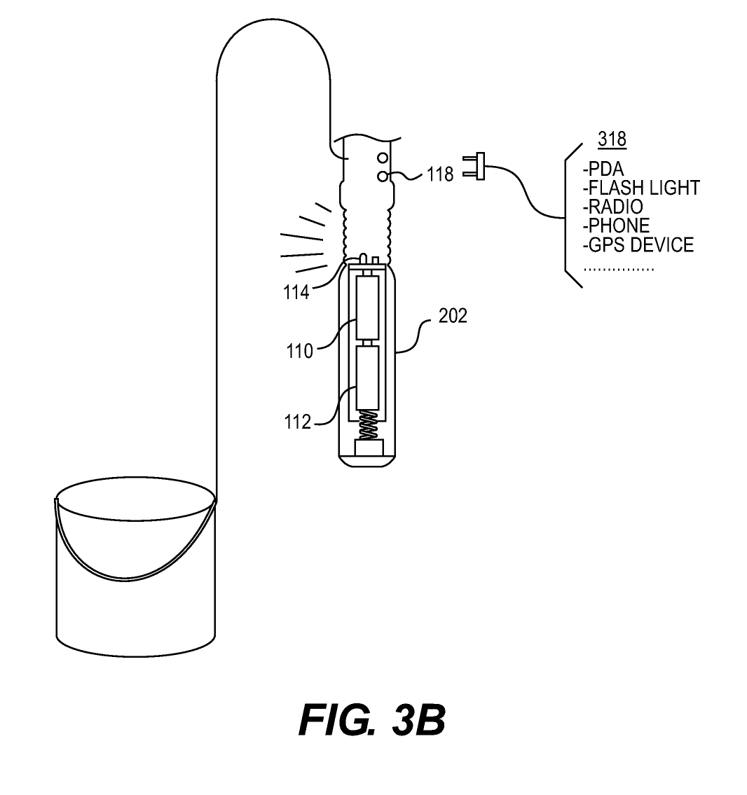

FIG. 3A illustrates a fishing equipment employing the power generation system being used by a fisherperson. As illustrated, a fisherperson 302 is using a fishing rod 304 and a reel assembly 306 coupled with a power generator operated by rotating a hand crank 104 as described in conjunction with FIGs. 1A-B and 2. The electrical energy generated by the generator 108 is used to illuminate an LED light bulb 310 located on the reel assembly, an LED bait light 122 located on the fishing rod 304 and a strike or bite indicator unit 218 located near a tip of the fishing rod 304.

FIG. 3B illustrates, further excess generated electrical energy is used to charge rechargeable batteries located within a removable handle 202 of the fishing rod, which is then used to power the fisherman's external electronic equipment 318 (PDA, Radio, Phone, Flashlight, GPS device, . . . etc . . . . An LED light 114, charge regulator 110 are provided on the handle portion 202. The LED 114 is powered by the rechargeable batteries 112 and may be designed to light up in dark in order to help the fisherman.

Therefore the present invention provides a power generator designed to generate electrical power on a fishing reel and can provide light for night fisherpersons, or power other electrical equipment. The system of the present invention creates electricity that can be directed toward convenient lights located on the reel as well as other fishing equipment. Excess electricity can be stored in a battery or capacitor, and can later be used for powering independent lights, radios, and other items requiring electrical sources. Hence, using the power generation system of the present invention eliminates the need for consumers to carry back-up equipment to prepare for possible failure of electronics, and also allows consumers to see easily while fishing in the dark.

While the exemplary embodiments of the present invention are described and illustrated herein, it will be appreciated that they are merely illustrative. It will be understood by those skilled in the art that various changes in form and detail may be made therein without departing from or offending the spirit and scope of the invention as defined by the appended claims.

What is claimed is:

1. A system for generation of power on a reel assembly coupled to a fishing rod, the system comprising:
a. a reel assembly comprising a hand crank capable of being manually rotated, wherein the hand crank coupled to a first gear;
b. a geared end electricity generator coupled externally to the reel assembly for generating electrical energy by converting the rotatory motion of the hand crank into electrical energy;
c. a gear track system comprising the first gear and being coupled between the first gear and the geared end electricity generator,
d. a slide switch is capable of engage or disengage the geared end electricity generator to the first gear, and
e. a removable handle including a power storage means coupled to the generator for storing the generated electrical energy.

2. The system as claimed in claim 1, wherein the hand crank is manually rotated for deployment and retrieval of a fishing line mounted on the fishing rod.

3. The system as claimed in claim 1, wherein the generator is coupled to a body of the reel assembly in a molded housing by way of a slide component with the slide switch.

4. The system as claimed in claim 1, wherein the generator generates electrical energy ranging from 3 to 12 VDC Volts.

5. The system as claimed in claim 1, wherein the generated electrical energy is used to power one or more LED lights located on the fishing rod.

6. The system as claimed in claim 1, wherein the generated electrical energy is used to power one or more LED lights located on the reel assembly.

7. The system as claimed in claim 1, wherein the generated electrical energy is used to power a bite indication unit coupled near the tip of the fishing rod.

8. The system as claimed in claim 1, wherein the generated electrical energy is selected to power electronics devices external to the fishing reel and the fishing rod, comprising cellular phones, personal digital assistants (PDAs), global positioning systems (GPS), radio, etc.

9. The system as claimed in claim 1, wherein the power storage means comprises one or more rechargeable batteries.

10. The system as claimed in claim 1, wherein the power storage means comprises one or more super capacitors.

11. The system as claimed in claim 1, wherein the power storage means further comprises a charge indicator in the range of low, middle, or fully charge.

12. The system as claimed in claim 1, further comprising a charge regulator for regulating the electrical voltage to +5 volts for the power storage means.

13. The system as claimed in claim 1, wherein the generated electrical energy being fed to the power storage means by means of electrical wires routed inside the reel assembly.

14. The system as claimed in claim 1, wherein the generated electrical energy is used to power electronics devices via an auxiliary jack located on a reel seat of the removable handle of a fishing rod, the electrical energy store in the power storage means being conveyed to the auxiliary jack by electrical wires.

15. The system as claimed in claim 1, wherein the generated electrical energy is used to power one or more devices via an electrical distribution board located on the fishing rod, the electrical energy store in the power storage means being conveyed to the electrical distribution board by electrical wires.

16. The system as claimed in claim 7, wherein the bite indicator unit further comprising: a low power battery 3 Volts, a buzzer, an LED light, a fishing line metal clamp for holding fishing line.

17. The system as claim in claim 15, wherein the buzzer, the LED light are ON when the fishing line is pulled out of the metal clamp by a fish.
